(19) United States
(12) Patent Application Publication
(10) Pub. No.: US 2016/0098745 A1
(43) Pub. Date: Apr. 7, 2016

(54) METHOD AND SYSTEM FOR MONITORING DELIVERABILITY AND ENGAGEMENT METRICS OF ELECTRONIC MAIL

(71) Applicant: Email Data Source, Inc., New York, NY (US)

(72) Inventors: Christopher Thomas ADAMS, Kansas City, MO (US); Gudmundur B. HEIDARSSON, Massapequa, NY (US)

(73) Assignee: EMAIL DATA SOURCE, INC., New York, NY (US)

(21) Appl. No.: 14/875,119

(22) Filed: Oct. 5, 2015

Related U.S. Application Data
(60) Provisional application No. 62/059,499, filed on Oct. 3, 2014.

(51) Int. Cl. G06Q 30/02; G06Q 10/10; H04L 12/58

(52) U.S. Cl. CPC G06Q 30/0246; H04L 51/34; H04L 51/12; G06Q 10/107

(57) ABSTRACT

A system and associated methods allows for better monitoring of email delivery operations through the collection of different types of raw email data. Different data sources may be used, such as virtual personas, seed-based accounts and real subscriber data from ISPs. This raw data is transformed into a common data format.

### FIELD OF THE INVENTION

The present invention relates to determining information about the effectiveness of electronic mail delivery and response using a plurality of data sources.

### BACKGROUND OF THE RELATED ART

Emails may be sent to a large number of recipients for a variety of reasons. Advertising, campaigns, awareness, school/education and the like use bulk email to get messages and information out quickly. It also is less expensive than regular mail, or sending paper home with students, employees, volunteers and the like.

Many emails, however, may not be received. Further, even if received, the email may not be opened or read. Thus, the sender does not know how effective their email campaign is.

### SUMMARY OF THE INVENTION

Thus, a method and system for monitoring deliverability and engagement metrics of electronic mail based upon virtual personas, real subscriber data and seed-based monitoring are disclosed. The method registers virtual personas with individual brands in order to receive email marketing communications. The method also registers subscribers through an online web-based email software-as-a-service (SaaS) product. The method also receives, at a single storage database, seed deliverability data indicating the number of email messages associated with the campaign that were delivered to the inbox or spam folders based upon all of the seed accounts. The seed accounts are not associated with human recipients of the email. The method also receives, at the single storage database, virtual personal emails that include a raw unique email message along with its deliverability placement in an inbox or spam folder based upon internal spam filtering. The virtual persona is a virtual account that mimics real-life users, including demographic information normally associated with such users.

The method also receives, at the single storage database, real subscriber emails that include the raw unique email message, message engagement information, and deliverability placement in an inbox or spam folder based upon the Internet service provider (ISP) message placement. The subscriber emails are associated with actual recipients of the email campaign. The method also determines deliverability and engagement metrics based upon a statistical combination of the virtual persona, seed and subscriber data, and matching a subscriber campaign by determining the most appropriate matching criteria. The matching criteria may include a rolling time window based upon one or more email header criteria, exact match based upon subject, sender and date, or custom x-header campaign identifications (ID) that is matched against the three data sources.

The disclosed embodiments also include matching subscriber campaigns to virtual personas by determining the best matching algorithm, including a rolling time window based upon subject and sender. They also match subscriber campaigns to seed campaigns by determining the best matching algorithm, including a rolling time window based upon subject and sender. The disclosed embodiments also may determine one or more deliverability metrics using a computational statistical algorithm to combine the seed, subscriber and virtual character data to generate deliverability and engagement metrics.

The disclosed embodiments also determine the best matching algorithm. The algorithm uses a computational process to determine which email headers, in addition to a rolling time window, to include as part of the match. The disclosed embodiments also receive raw email messages directly from one or more internet service providers (ISPs). The subscriber email is obtained using a processor that communicates directly with the email provider via a direct communication protocol. The disclosed embodiments also automatically use a new transformed dataset based upon a statistical combination of the subscriber, virtual character and seed data.

### BRIEF DESCRIPTION OF THE DRAWINGS

The accompanying drawings are included to provide further understanding of the disclosed embodiments and constitute a part of the specification. The drawings listed below illustrate embodiments of the claimed invention and, together with the description, serve to explain the principles of the invention, as disclosed by the claims and their equivalents.

FIG. 1A illustrates a block diagram of a system for sending and delivering an email according to the disclosed embodiments.

FIG. 1B illustrates a block diagram showing a sequence of events when a user sends an email message, or an electronic document, over a network according to the disclosed embodiments.

FIG. 1C illustrates a block diagram of some hardware components to interact with a system and perform actions according to the disclosed embodiments.

FIG. 2 illustrates a system for monitoring deliverability and engagement metrics of email based on a plurality of data sources according to the disclosed embodiments.

FIG. 3 illustrates a flowchart for registering a virtual persona account according to the disclosed embodiments.

FIG. 4 illustrates a flowchart for tracking emails to generate data according to the disclosed embodiments.

FIG. 5 illustrates a flowchart for monitoring data from a plurality of email sources according to the disclosed embodiments.

FIG. 6 illustrates a flowchart for a campaign identification and deliverability process according to the disclosed embodiments.

FIG. 7 illustrates a flowchart for accessing deliverability information according to the disclosed embodiments.

FIG. 8 illustrates a screenshot of a deliverability dashboard according to the disclosed embodiments.

FIG. 9 illustrates a screenshot of a campaign view dashboard according to the disclosed embodiments.

FIG. 10 illustrates a screenshot of a combined deliverability and engagement dashboard according to the disclosed embodiments.

### DESCRIPTION OF THE PREFERRED EMBODIMENTS

Aspects of the invention are disclosed in the accompanying description. Alternate embodiments of the present invention and their equivalents are illustrated without parting from the spirit or scope of the present invention. It should be noted that like elements disclosed below are indicated by like reference numerals and the drawings.

The disclosed embodiments include systems and methods for monitoring delivery of electronic mail based on a combination of data sources. The data sources according to the disclosed embodiments include virtual personas, seed-based accounts, and real subscriber data from multiple internet service providers (ISPs).

The process of seeding is one in which multiple email accounts are created at multiple ISPs. Senders of emails are provided with a list of these accounts to be inserted into their outbound marketing messages. The deliverability of this data may be monitored to determine whether the messages arrived within an inbox, a spam folder or were not delivered. In addition, seed monitoring also tracks the spam score assigned to the message as well as images that the message displays within the different ISPs webmail clients or devices.

Virtual personas are virtual users created using a plurality of domains in accordance with the disclosed embodiments. The virtual users are given real names, ages, postal addresses, phone numbers, demographic information and the like. An internal research team then goes to multiple brand websites and registers to receive marketing messages as that virtual user. Electronic mail is collected by an internal mail processing system that tracks the virtual persona being sent the message, as well as the ability to determine an internal deliverability score based upon custom spam filtering software.

Subscriber deliverability email includes electronic communications collected from actual customer email accounts. A data collection processor interacts directly with each of the major ISPs via one or more communication channels, including IMAP and REST. When an email is sent by a recognized commercial sender, that raw email is immediately flagged and transferred to the data collection processor, where it is anonymized, parsed and collected, while ensuring the safeguarding of the consumer panel.

To ensure scalability and the ability to handle the processing of hundreds of millions of messages per day, the data is transferred to a distributed processing system and picked up by the input parser factory. The input parser factory determines the type of data being processed and transforms it into a normalized set of raw data points. These data points include, but are not limited to, subject, from-address, anonymized to-address, received addresses, anonymized, parsed and tokenized body content, as well as delivery location and engagement data. Engagement event data includes whether a user read the message, deleted the message, sent the message to spam and other possible actions.

Once the data has been transformed into a common dataset, it is then matched with other identical email campaigns based upon a time based-rolling window algorithm that considers one or more data points in determining the match. The data then may be stored into a single common data store and available for additional processing, external API access, cloud-based bulk transfers, a centralized deliverability-monitoring tool, or other distribution channels.

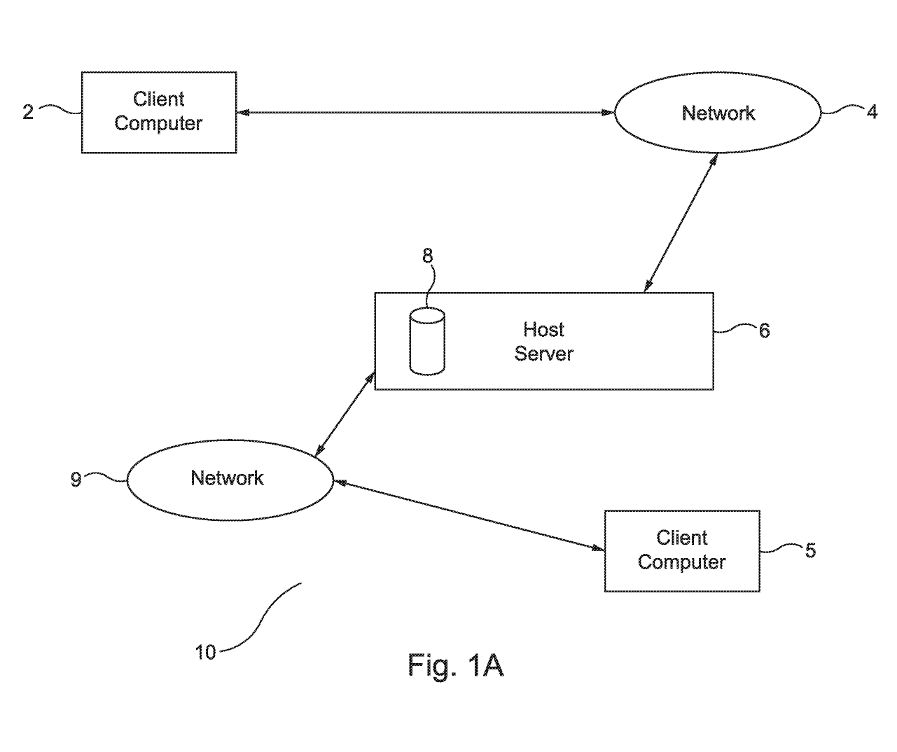

FIG. 1A depicts a block diagram of a system 10 for sending and delivering an email according to the disclosed embodiments. System 10 represents various components to illustrate the methods and features disclosed below. System 10 is not all-inclusive of every component available for use in accordance with the disclosed embodiments. System 10 includes a first client computer 2, a host server 6, computer networks 4 and 9, second client computer 5, and database 8. Other components may be included in system 10, though not shown in FIG. 1.

Host server 6 includes one or more server computers, computing devices or systems to store data. Host server 6 is shown and referred to as a single server for clarity. Host server 6 may be a plurality of servers connected within a network accessible by system 10 and connected by hardware and software operable to perform the functions disclosed below. These collection of servers may communicate using a protocol. Preferably, host server 6 is a mail server to receive and forward email messages within system 10.

Database 8 may reside on host server 106. Database 8 also may reside on a server or computing device removed from host server 6, provided that the remote server or computing device is capable of bi-directional electronic communication with host server 6. The remote server or computing device upon which database 8 resides may be operated by, or under the control of, a system operator. The remote server or computing device upon which database 8 resides is electronically connected to host server 6 such that the remote server or computing device is in continuous bi-directional communication with host server 6.

For purposes of clarity, database 8 is shown in FIG. 1, and referred to herein as a single database. Database 8 may include a plurality of databases connected within system 10.

Computer network 4 and computer network 9 are shown as distinct computer networks, but may be one computer network residing in system 10. Either computer network may be a global computer network, such as the Internet. Preferably, a computer network according to the disclosed embodiments includes a plurality of computers, servers, devices and the like connected together via the network to exchange information.

First client computer 2 and second client computer 5 may be computers, computing devices, smartphones, tablets, or any other devices capable of connecting to one of the computer networks in system 10. For illustrative purposes, first client computer 2 is used as an email sender. An email may be created at first client computer 2 that is sent onto system 10. Second client computer 5 is used as an email recipient. The email is opened and viewed at second client computer 5. First client computer 2 and second client computer 5 may represent a plurality of computers such that an email may be generated and sent to any number of client computers within system 10. For example, first client computer 2 may be a company hosting an email campaign to promote its goods and services through emails sent to thousands or even millions of second client computers 5. Further, a client computer as used in this disclosure may refer to any device capable of displaying emails, either in part or in total, on the device.

First client computer 2 may include a software program or instructions, or an application, to facilitate the sending and receipt of emails, and to browse the Internet. Second client computer 5 may include a software program or instructions, or an application, to retrieve email messages from an email account accessible over computer network 9. These applications also allow users of the client computers to view emails, compose a response to an email, archive an email, delete an email, and the like.

A user may use the data entry features of first client computer 2 to compose an email addressed to at least one email recipient. The email then may be sent and retrieved by the recipients by the example process disclosed below. Other processes may be used.

According to a first example process, the user of first client computer 2 sends the email to each email recipient after the email is generated. The email is processed by host server 6 and database 8 in route to second client computer 5. Processes associated with database 8 may cause a sub-message to be appended to the email. For example, a company standard promotion or other information may be added to the email. A logo, image, or graphic for the company may be added. After the sub-message is appended, the email is delivered through computer network 9 to each recipient. Alternatively, a URL or any other information may be appended to the email.

FIG. 1B depicts a block diagram showing a sequence of events when a user sends an email message, or an electronic document, over a network according to the disclosed embodiments. The sequence of events may occur using the components disclosed above. Alternatively, the disclosed sequence may use other components as needed. In block 150, a user Alice types in, or selects from an address book, the email address of the intended recipients, types a message having information, and hits the “send” button using a mail user agent (MUA). The message includes information about a campaign targeted to the recipient of the email. Alice's MUA formats the message into an Internet or computer network email format and may use the Simple Mail Transfer Protocol (SMTP) to send the message to the local mail transport agent (MTA), in this case smtp.a.org, managed by Alice's Internet Service Provider (ISP).

The MTA reads the destination address provided by SMTP, in the example shown as bob@b.org, and, in block 52, looks up the associated domain name in the Domain Name System (DNS) to find the mail exchange servers accepting messages for that domain. In block 54, the DNS server for the b.org domain, or ns.b.org, responds with a mail exchange (MX) record listing the MX servers for that domain, which in this example is mx.b.org, a server run by the recipient's ISP. In block 56, Alice's MTA, or smtp.a.org, sends the message to mx.b.org using SMTP, which delivers it to the mailbox of user Bob (or other users, if applicable). In block 58, Bob presses the “get mail” button in his MUA that retrieves the message using POP or another suitable protocol.

The block diagram in FIG. 1B is shown for illustrative purposes. According to the disclosed embodiments, an email created by “Alice” would be sent to many recipients. In fact, Alice would be a company or organization creating emails for use in a campaign. The emails would include information related to the campaign for receipt by a large number of recipients. Further, a header or subject line may include information specifically related to the campaign, such as a name, brand, location and the like.

Bob, as referred to above, may include seed recipient accounts, virtual persona accounts or subscriber accounts. Further, some of Bob's actions, such pressing a “get mail” button, may be done automatically at a specified time or when the email account is activated. For seed and virtual persona email accounts, an automated process may receive and log the email.

FIG. 1C depicts a block diagram of some hardware components to interact with system 10 and perform actions disclosed above according to the disclosed embodiments. FIG. 1C refers to client computer 2 of system 10, but may be any computer used to prepare, send, receive or open emails. Client computer 2 may refer to any type of computer, information processing system, or other programmable electronic device, including a client computer, a server computer, a portable computer, an embedded computer, a personal digital assistant, a Cloud computing device, a smart television, a smart watch, and the like. For example, the features of FIG. 1C also may apply to host server 6, client computer 5 and the like. Aspects of the disclosed embodiments may be distributed amongst one or more networked computing devices that interact with computer 2. For ease of understanding, however, aspects of the disclosed embodiments have been embodied in a single computing device, shown as an example as computer 2.

Computer 2 may be a stand-alone device or networked with computer architecture. Computer 2 is in communication with other networked computing devices, such as those shown in FIG. 1A, via network 9. Network 9, as noted above, may include one or more of the following: local area networks, wide area networks, intranets, public/private Internet, virtual networks, ad-hoc networks and the like.

Computer 2 includes processor device 62 that communicates with an input/output subsystem 64, memory 66, storage 68 and network 9. Processor device 62 is operably coupled with a communication infrastructure, or bus, 70. Bus 70 may be a communications bus, cross-over bar bus or network bus. Processor device 62 may be a special purpose microprocessor operating under control of computer program instructions 72 executed from memory 66 on program data 74. Processor device 62 may include a number of special purpose sub-processors such as a comparator engine, each sub-processor for executing particular portions of the computer program instructions. Each sub-processor may be a separate circuit able to operate substantially in parallel with the other processors.

Some or all of the sub-processors may be implemented as computer program processes, such as software, tangibly stored in a memory that perform their respective functions such as a general purpose integrated circuit microprocessor, or each sub-processor may have its own processor for executing instructions. Alternatively, some or all of the sub-processors may be implemented in an application-specific integrated circuit (ASIC).

Memory 66 may be partitioned or otherwise mapped to reflect boundaries of the various memory sub-components. Memory 66 may include both volatile and persistent memory for the storage of operational instructions 72 for execution by processor device 62, data registers, application storage and the like. Memory 66 may include a combination of random access memory (RAM), read only memory (ROM) and persistent memory such as that provided by a hard disk drive 76. The computer instructions/applications that are stored in memory 66 are executed by processor 62. In this manner, instructions 72 within memory 66 may turn a general processor device 62 into a special purpose processor device. In some embodiments, computer instructions/applications 72 and program data 74 may be stored in hard disk drive 76 for execution by processor device 62.

I/O subsystem 64 may comprise various end user interfaces such as a display, a keyboard and a mouse. Alternatively, I/O subsystem 64 may include a graphical user interface (GUI) that allows a user to input information to computer 2. I/O subsystem 64 further may comprise a connection to network 9 such as a local area network (LAN) or wide area network (WAN), or the Internet. Computer system 2, therefore, may access email applications 78 through network 9. Email applications 78 may correspond to the embodiments disclosed below for monitoring deliverability and engagement metrics of email based on a plurality of data sources and support the actions disclosed in FIG. 1B.

Computer 2 also may include a removable storage drive 68, representing a disk drive, a stand-alone hard disk, a flash drive, an optical disk drive and the like. Removable storage drive 68 reads from and/or writes to a removable storage unit 80. Removable storage unit 80 also may be a disk drive, a stand-alone hard disk, a flash drive, CD-ROM, DVD-ROM, an optical disk drive and the like, which is read by and written to by removable storage drive 68. Removable storage unit 80 may include a non-transitory computer-readable medium having stored therein computer software or data.

Computer 2 also may include a communications interface 82. Communications interface 82 allows software and data to be transferred between the computer and external devices. Examples of a communications interface 82 may include a modem, a network interface such as an Ethernet card, a communications port, a PCMCIA slot and card, and the like. Software and data transferred via communications interface 82 may be in the form of signals, such as electronic, electromagnetic, optical, or any format capable of being received by a communications interface.

Processor 62 may be configured to execute instructions 72 to perform the actions disclosed below. Further, any computer according to the disclosed embodiments may be programmed to become a special purpose computer to monitor deliverability and engagement metrics of email based on a plurality of data sources. As disclosed, other “processors” are disclosed to perform specific functions. These processors may correspond to processor 62, or may include sub-processors as disclosed above to perform the specific functions.

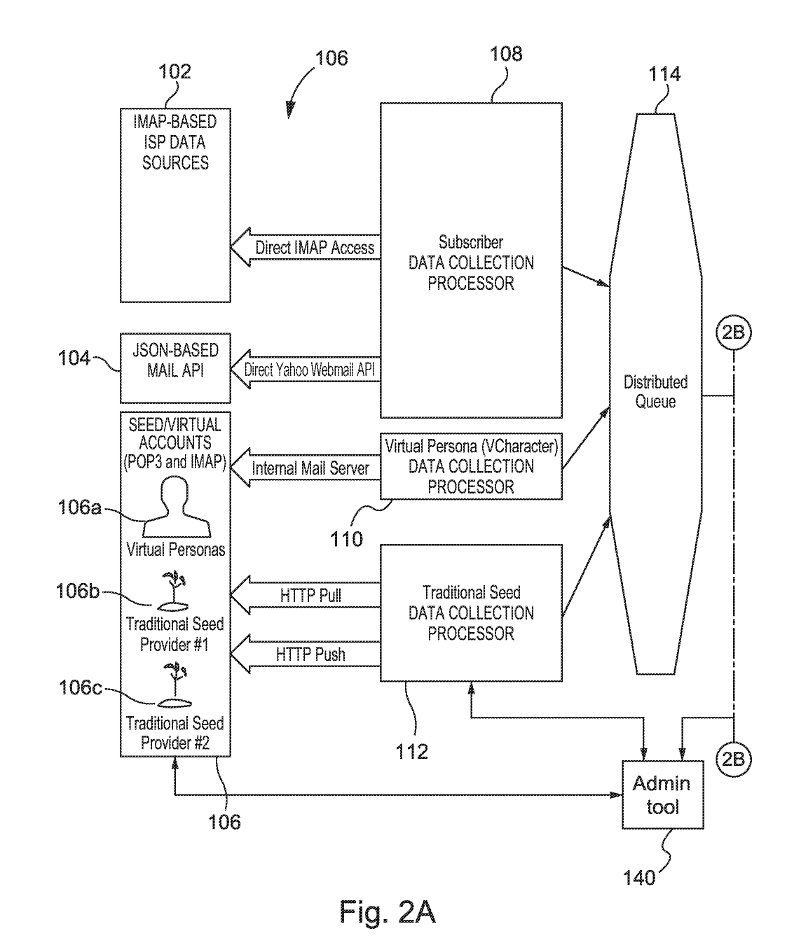

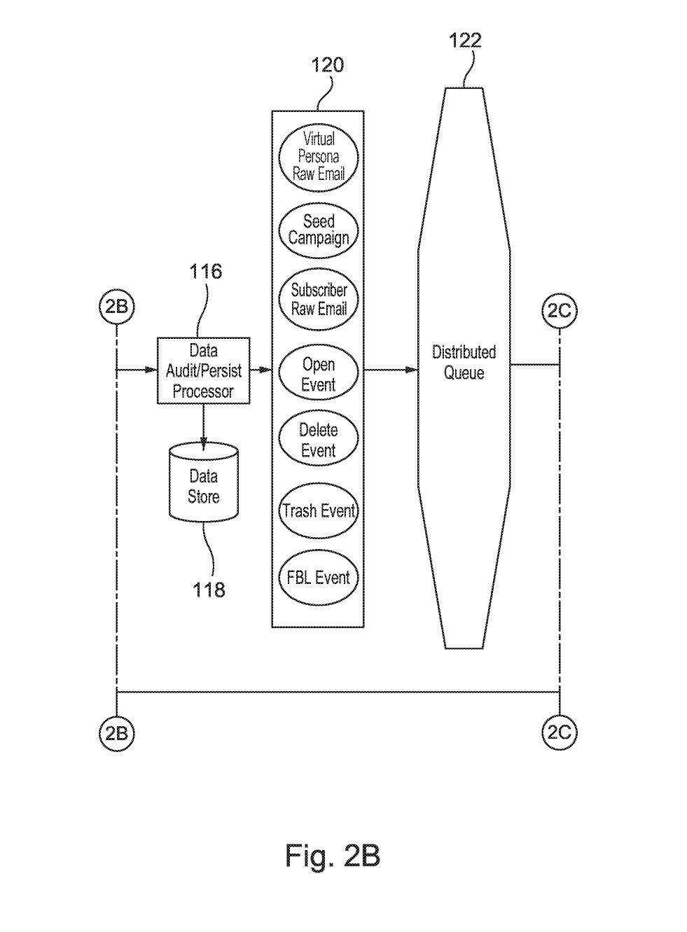

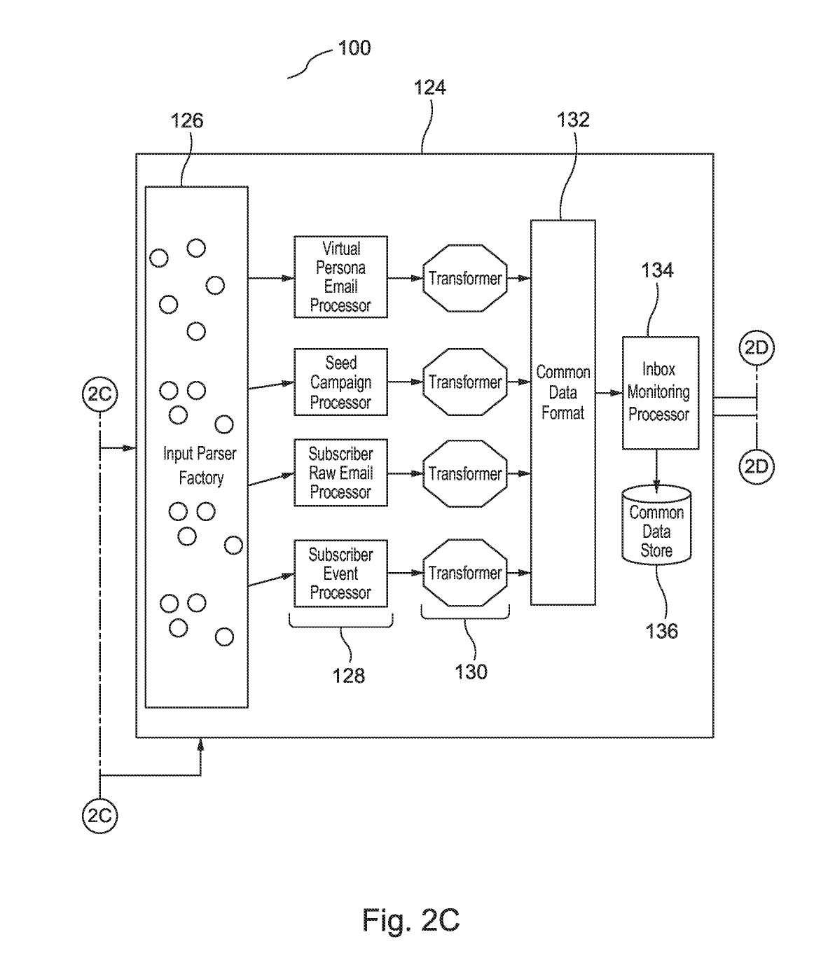

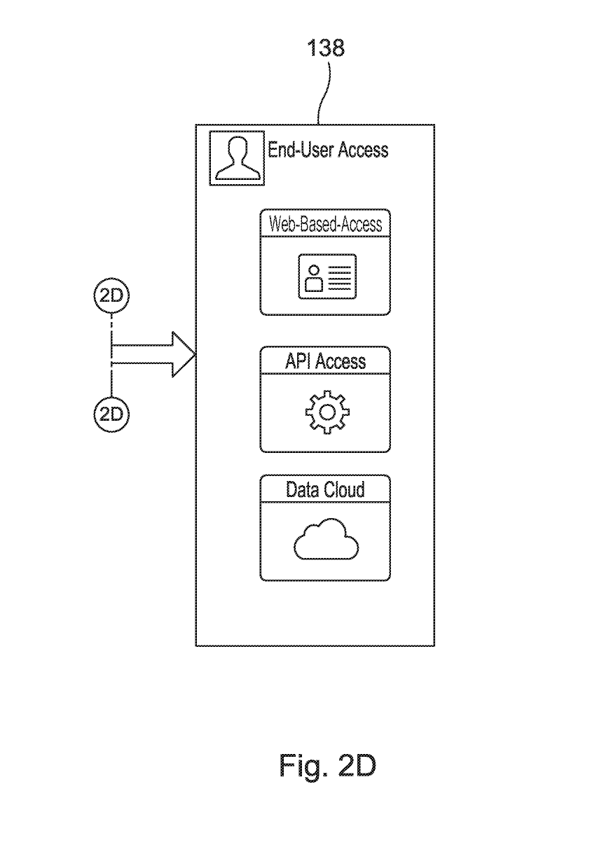

FIG. 2 depicts a system 100 and associated flow diagram for monitoring deliverability and engagement metrics of email based on a plurality of data sources according to the disclosed embodiments. System 100 monitors the delivery of electronic mail based upon a combination of data sources. Referring to FIG. 2, data sources 102, 104 and 106 are shown. The data sources presented within FIG. 2 include virtual personas, seed-based accounts, and real subscriber data from multiple Internet service providers (ISPs). Additional data sources also may be used and the disclosed embodiments are not limited to the examples shown herein.

Thus, the disclosed embodiments may seed various accounts to determine and gather information regarding the metrics of email delivery. The process of seeding includes creating multiple email accounts at multiple ISPs. Senders of the email are provided with a list of these accounts to be inserted into their outbound marketing messages. The deliverability of this data is monitored to determine whether the messages arrived within the designated inboxes, spam folders, or were not delivered. In addition, seed monitoring also tracks the spam score assigned to the message as well as images of the message as it displays within the different ISPs webmail clients or devices.

Data source 102 includes IMAP-based ISP data sources, such as GMAIL™, AOL™ and the like. Data source 102 may include a plurality of data sources, each having its own platform to send and receive emails. Data source 102 may be known as subscriber deliverability email source. JavaScript Object Notation (JSON)-based mail application program interface data source 104 also is included. Subscriber deliverability email includes electronic communications collected from actual customer email accounts. Data collection processes initiated by the associated processor interact directly with each of the major ISPs, such as GMAIL™, OUTLOOK™, AOL™, HOTMAIL™, YAHOO™ and the like via one or more communication channels 106, including IMAP and REST.

Data sources 102 and 104 also may be known as panel and engagement data sources. A panel data source may be a subscription-based email account for a real user. The disclosed embodiments may access and monitor the emails sent to this account. An engagement data source may track what a user does with the email, such as read, open, delete and the like. Information provided by a panel data source may be provided in large batches of data.

Data source 106 differs from data sources 102 and 104 in that the email accounts providing the email data are not actual subscriber accounts. Instead, these accounts are created for the purpose of monitoring deliverability and determining engagement metrics. Data source 106 is further broken into data sources of virtual personas 106A, traditional seed provider 106B and traditional seed provider 106C.

Virtual persona data source 106A are a proprietary data source of the disclosed embodiments that allows virtual users to be created using a plurality of domains owned by an administrative user, such as the assignee of the present application. The virtual users are given real names, ages, postal addresses and phone numbers like actual users. An internal research team then goes to multiple brand websites and registers to receive their marketing messages as those users. Electronic mail is collected by an internal mail processing system that tracks the virtual persona configured to receive the message, as well as the ability to determine an internal deliverability score based upon custom spam filtering software.

Seed delivery data sources 106B and 106C may act as traditional seed providers. The data from these sources may reflect machine-based accounts added to the email list. Seed accounts are not associated with an actual recipient of the messages. Seed accounts and seed data are used to monitor deliverability and not to actually send email. They may act as dummy accounts for the purposes of the disclosed embodiments.

When an email is sent by a recognized commercial sender, that raw email is flagged immediately and transferred to the appropriate data collection processor. The raw email is anonymized, parsed, and collected, while ensuring the safeguarding of the consumer panel. Thus, subscriber data collection processor 108 may collect the raw email data from data sources 102 and 104 using a direct IMAP access channel and a direct webmail API channel.

Virtual persona data collection processor 110 collects the raw email data from data source 106A using an internal mail server channel. Traditional seed data collection processor 112 may use an HTTP pull channel and an HTTP push channel to obtain the seed data from internal seed accounts or third-party seed account services, or data sources 106B and 106 C. As disclosed above, processors 108, 110 and 112 may be sub-processors configured within a processor.

Processors 108, 110 and 112 then provide their respective raw data feeds for all the data sources to distributed queue 114. Data audit/persist processor 116 may pull the email data from distributed queue 114 as needed from the different processors, thus ensuring a decoupling from the data collection and data processing services. Data audit/persist processor 116 may store all of the data in data store 118. Thus, one database may store all the data collected by processors 108, 110 and 112. Collected data 120 is pulled by distributed queue 122 to transfer to distributed processing system 124.

To ensure scalability and the ability to handle the processing of hundreds of millions of messages per day, distributed processing system 124 is used to turn the raw consumer data into a combined data set with a common format. Thus, input parser factory 126 determines the type of data being processed and sends each of the data to the appropriate processor 128. Processors 128 may include a virtual persona email processor, a seed campaign processor and a subscriber raw email processor.

The disclosed embodiments also include a subscriber event processor within processors 128 to handle events associated with the received email account data. Transformers 130 transform, or modify, the disparate types of data into a normalized set of raw data points. This may be shown as common data 132 having a common format. The normalized set of raw data points include, but are not limited to, subject, from-address, anonymized to-address, received addresses, anonymized, parsed and tokenized body content as well as delivery location and engagement data. Engagement event data includes whether a user read the message, deleted the message, sent the message to spam, and the like.

Transformers 130 may use algorithms to transform the raw data into the normalized data 132. This set of data may then be received by inbox monitoring processor 134. Inbox monitoring processor 134 may match up the received data with other identical email campaigns based upon a time based-rolling window algorithm that considers one or more data points in determining the match. The time based-rolling window algorithm may introduce a matching concept where the length of time between sent emails impacts the matching algorithm. If email data keeps coming for a campaign, the matching algorithm of the disclosed embodiments will keep associating the email data with that same campaign. However, if enough time lapses between email X and email Y, then email Y may be treated as a new campaign, even if the other matching criteria is identical.

The data may then be stored into a single common data store 136 to be available for additional processing, external API access, cloud-based bulk transfers, a centralized deliverability-monitoring tool or other distribution channels. End-user access module 138 may facilitate in these functions. Consumers may access the stored data using module 138.

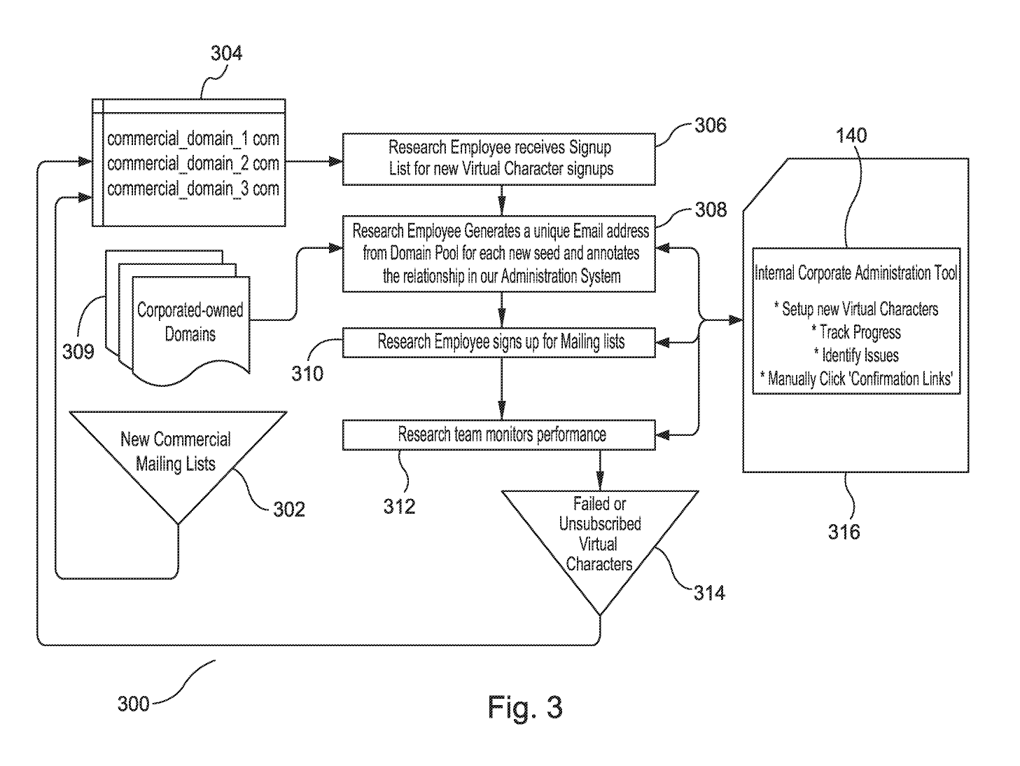

FIG. 3 depicts a flowchart 300 for registering a virtual persona according to the disclosed embodiments. Step 302 executes by generating new commercial mailing lists. A commercial mailing list may be lists for campaigns, companies, and the like that desire to send a large number of emails to recipients. The large number of recipients is used to generate the data used by data collection processors 108, 110 and 112. For example, one commercial mailing list may be for a political campaign while another may be for a charity looking to promote an event.

Step 304 executes by defining the commercial domains associated with the new commercial mailing lists. Using the above example, the political campaign probably has a website to sign up for emails and alerts. The charity may have several websites, such as national, state and local commercial domains to sign up for emails and alerts. Thus, step 304 may associate the various commercial domains with the commercial mailing lists. In some embodiments, the commercial domains may be known by their uniform resource locators (URLs).

Step 306 executes by receiving a signup list for new virtual character, or account, signups. In some embodiments, an employee may receive the signup list to create new virtual accounts for the different commercial domains defined in step 304. The virtual accounts may include information similar to a real email account, such as a name, age, and other demographic information. The demographics may be automatically generated for the virtual account. Step 308 executes by generating a unique email address from a domain pool for each new virtual account. Step 308 also may annotate the relationship between the unique email address and new account in an administration application tool. Step 309 executes by providing the corporate-owned domains to step 308 for use of the domain pools to generate the unique email addresses.

Step 310 executes by signing up for the commercial mailing lists generated above. The employee may go to the commercial domains and create an account using the unique email address for the virtual account. When signing up for a commercial mailing list, the virtual email account demographic information may be used to provide information for the mailing list. Step 312 executes by monitoring performance by a research team. Performance includes receipt of emails, whether the emails for which the virtual account is registered goes to a spam folder or are blocked, and the like. Step 314 executes by taking the performance information and generating failed or unsubscribed virtual characters. This step includes determining those commercial domains that no longer exist or do not work. Flowchart 300 flows from step 314 to step 304 to update the appropriate commercial domains.

Step 316 may execute separate from the other steps of flowchart 300. Step 316 may provide an administration tool 140 for use with the disclosed embodiments. Administration tool 140 may be known as an internal corporate administration tool. In other words, administration tool 140 is used by monitoring users to help facilitate the gathering of information regarding the virtual accounts. Step 316 allows administration tool 140 to interact with steps 308, 310 and 312 to provide setting up new virtual characters, or accounts. Administration tool 140 may generate information needed to create the virtual accounts. It also may track progress, identify issues and “manually click” confirmation links, much like a real user. For example, administration tool 140 may click on a link embedded in an email for the political campaign to “vote” on an issue.

Thus, virtual personas 106A in FIG. 2 may be created and monitored using the embodiments disclosed in FIG. 3. Other processes may be used to aggregate the information for the virtual accounts for use in system 100. The processes disclosed by FIG. 3 also may be used in creating seed accounts, except, possibly, for the use of administrative tool 140.

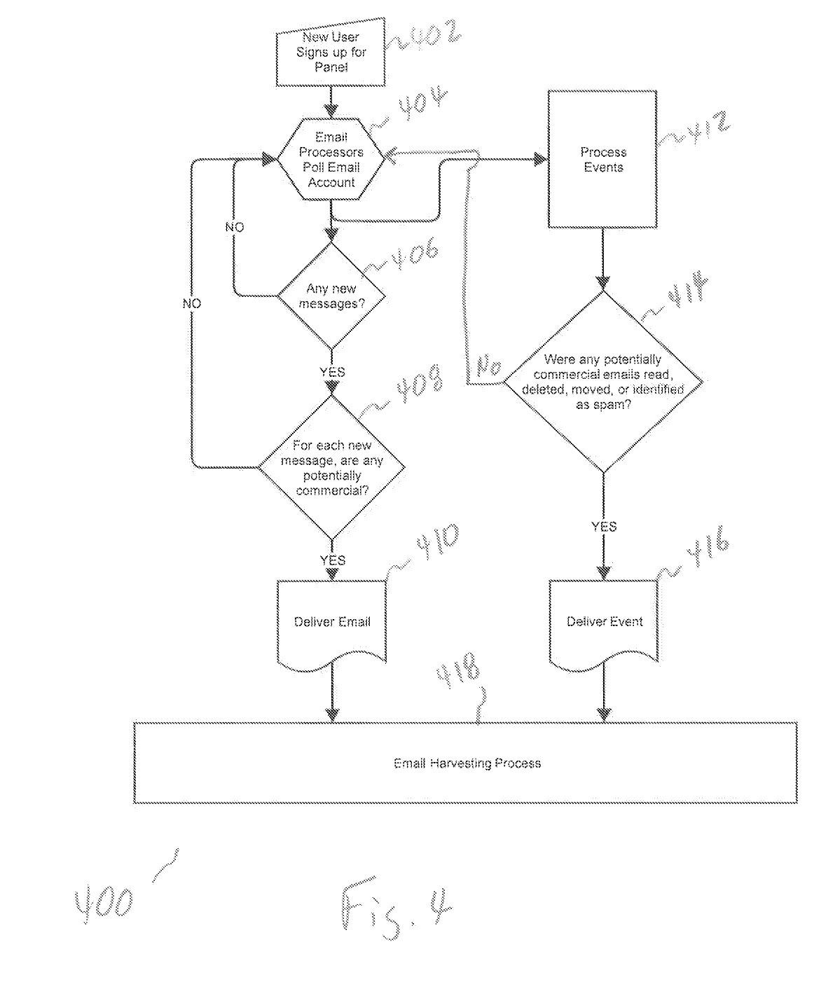

FIG. 4 depicts a flowchart 400 for tracking emails to generate data according to the disclosed embodiments. Flowchart 400 may focus on subscriber or panel-based email accounts. Referring to FIG. 2, this is the data provided by data sources 102 and 104. Flowchart 400, however, may be used in conjunction with seed and virtual persona email account data collection, or harvesting.

Step 402 executes by having a new user sign up for panel monitoring. Virtual accounts and seed accounts may automatically be signed into this service. In other words, these accounts are subject to monitoring according to the disclosed embodiments and do not have to “sign up” as a subscriber or panel account does. Step 402 may be the only step that applies to panel, or actual, accounts based on ISP data sources.

Step 404 executes by polling the email account by the email processors. Step 406 executes by determining whether any new messages have been received in the email account. If no, then flowchart 400 returns to step 404 to wait until the next polling cycle. In some embodiments, when the process returns to step 404, a period of time may elapse before step 404 is executed.

If step 406 is yes, then step 408 is executed to determine whether any potentially commercial emails exist for each new message. A commercial email may be one that asks a user to respond to something within the email. Using the examples above, the political campaign email may link to an article or survey. It also may include directions to a political rally or event. A charity-related email also may include links or information, or possibly an attachment to download by the recipient. In other words, a commercial email is not individually personal to the recipient. The disclosed embodiments may provide parameters to determining whether an email is commercial.

If step 408 is no, then flowchart 400 returns to step 404 to poll the email accounts. If step 408 is yes, then step 410 executes by delivering the email to an email harvesting process executed in step 418. The email harvesting process may collect data and information pertaining to a large number of email accounts to supply information to processors 108, 110 and 112 for system 100. The email harvesting process may store the email account for later retrieval.

Flowchart 400 may execute step 412 after step 404. Step 412 executes by processing events performed on the email within the account of interest. Step 414 executes by determining whether any potentially commercial emails were read, deleted, moved or identified as spam. In other words, step 414 determines whether any action was taken on the email aside from being delivered to the email account. If no, then flowchart 400 returns to step 404. If yes, then step 416 executes by delivering the event information (such as action taken) to the email harvesting process of step 418. The event information may be included with the email that was determined to a commercial email.

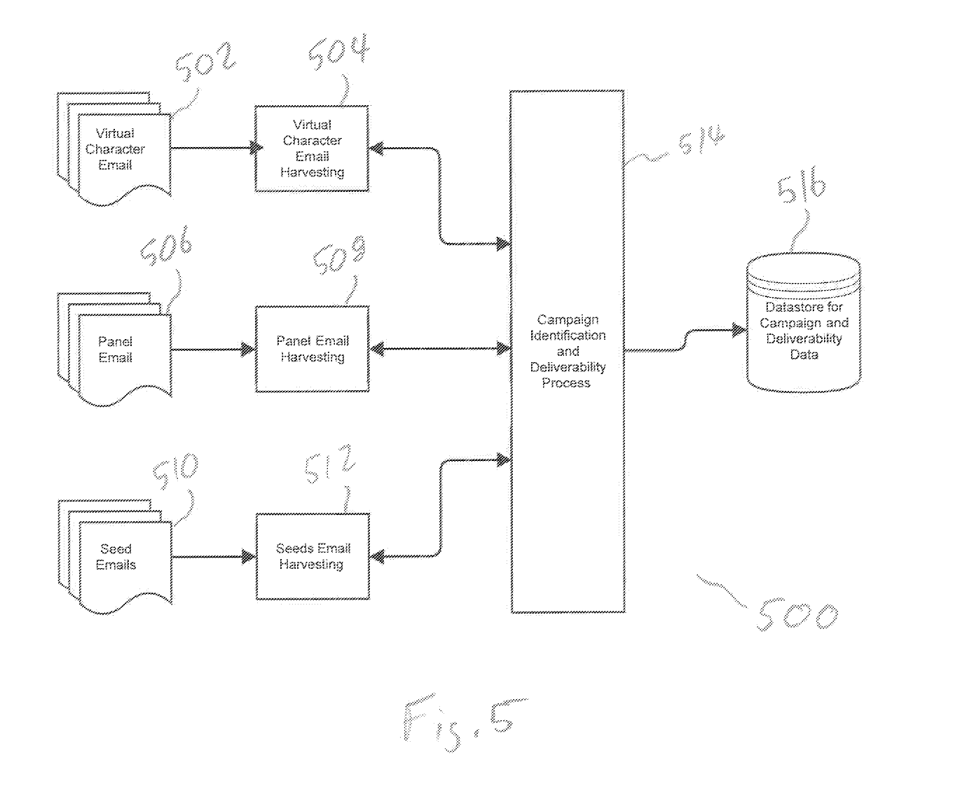

FIG. 5 depicts a flowchart 500 for monitoring data from a plurality of email sources according to the disclosed embodiments. Step 502 executes by collecting all the virtual character email account activity. This step may be performed similar to the processes disclosed by FIG. 4. Virtual persona emails 106A may be brought into virtual persona data collection processor 110. Step 504 executes by harvesting the virtual character email data using processor 110, queue 114 and persistent processor 116. For example, emails including commercial information and being subject to an action is harvested for the virtual accounts.

Step 506 executes by collecting all the panel email account activity, preferably using a process such as one disclosed in FIG. 4. As recipients check their emails, then information and data is generated regarding the actions taken with commercial emails. The panel email accounts may be shown as data sources 102 and 104 in system 100. The emails from these data sources are input to subscriber data collection processor 108. Step 508 executes by harvesting the panel, or actual, email deliverability information using processor 108, queue 114 and persistent processor 116. For example, panel or subscriber (actual) emails determined to be for commercial purposes are identified and harvested

Step 510 executes collecting the seed account email activity. As noted above, seed accounts act like dummy accounts in that they just receive mail. Seed email accounts may be shown as traditional seed provider accounts 106B and 106C. The seed account information is input into seed data collection processor 112. No actions are taken on the emails in the seed accounts, such as forwarding the email, deleting the email, and the like. Step 512 executes by harvesting the seed email account information using processor 112, queue 114 and persistent processor 116.

Steps 504, 506 and 508 may be directed by flowchart 500 to step 514. Step 514 executes by performing a campaign identification and deliverability process. This step is disclosed in greater detail below. Step 514 also may store the associated emails with the campaigns to a data store, or database, 516 for campaign and deliverability data. Data store 516 may correspond to data store 118 disclosed above. These actions may be performed by using collected data 120 and distributed queue 122.

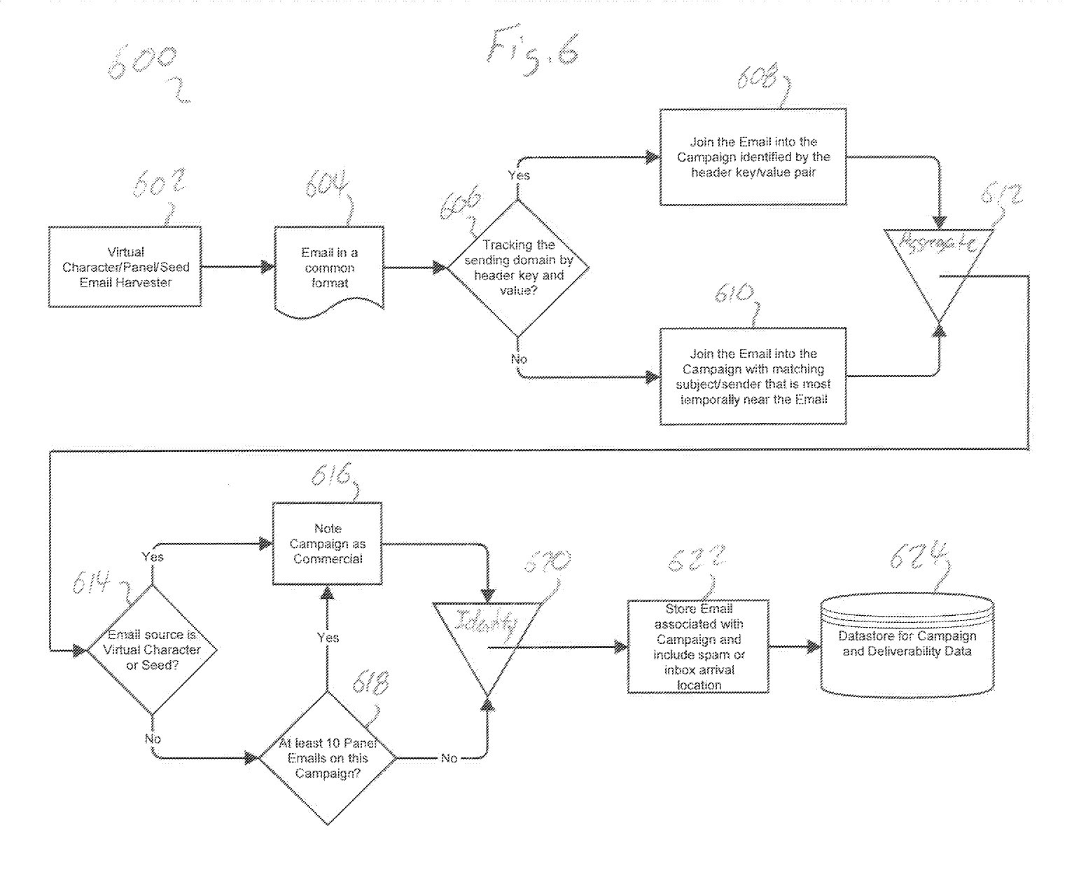

FIG. 6 depicts a flowchart 600 for a campaign identification and deliverability process according to the disclosed embodiments. Step 602 executes by aggregating all the available emails and account information using the virtual character/panel/seed harvesting processed disclosed above. Step 604 executes by putting an email harvested from the data sources and accounts into a common format. Alternatively, step 604 may check to see if the email has a common format.

Step 606 executes by determining whether the sending domain of the email of interest is tracked by header key and value. In other words, the header key could be of interest to campaigns associated with those signed up by the process disclosed in FIG. 3. The headers for these campaigns may include a common key or personalized subjects to tag the emails as pertaining to the campaign. Thus, if step 606 is yes, then step 608 executes by matching the email into the campaign identified by the header key/value pair. If step 606 is no, then step 610 executes by matching the email into the campaign with a matching subject/sender that most temporally near the email. In other words, the email may be matched to campaigns having similar subjects of other emails associated with the campaign. The emails may be grouped together by these subjects. In some embodiments, a threshold may be set to determine the similarity before placing the email into a category.

Step 612 executes by aggregating the results of matching within steps 608 and 610. Step 614 executes by determining whether the email source is a virtual character or a seed account. Step 614 may determine whether the email came from data sources 106A-C. If yes, then step 616 executes by noting that the campaign for the email is commercial. If step 614 is no, then step 618 executes by determining whether a certain number of panel emails on the campaign of the email have been presented. In some embodiments, the threshold number may be 10. If at least 10 panel emails have been associated with the identified campaign, then step 616 is executed to note that the campaign is commercial.

If step 618 is no, then flowchart 600 bypasses step 616 and flows to step 620. Step 620 executes by identifying the campaign for the email as commercial or personal. Step 622 executes by storing the email associated with the campaign and its categorization, and including spam or inbox arrival location. This information may be stored in data store 624, which corresponds to data store 516 and data store 118. Data store 624 may include campaign and deliverability data for the emails. Other information associated with the emails may be inbox or spam associated deliverability information.

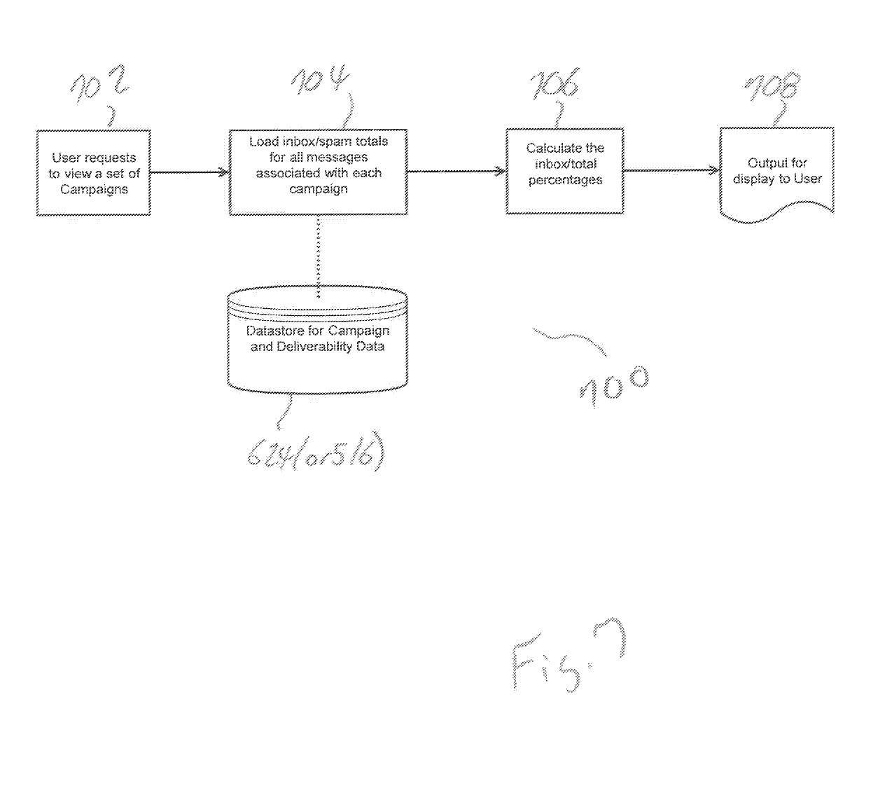

FIG. 7 depicts a flowchart 700 for accessing deliverability information according to the disclosed embodiments. Step 702 executes by a user requesting to view a set of campaigns with associated email deliverability data. For example, the user behind the political campaign would like to view the metrics of the emails being sent to the list of accounts.

Step 704 executes by loading the inbox and spam totals for all messages associated with each campaign. Step 704 may access one of the data stores disclosed above, such as data store 624, 516 or 118. Step 706 executes by calculating the inbox deliverability data in view of the total emails sent for percentages of interest. Step 708 executes by outputting this information to the user. For example, the user may view the information displayed on a computer screen. Alternatively, a document of the calculated percentages may be sent to the user.

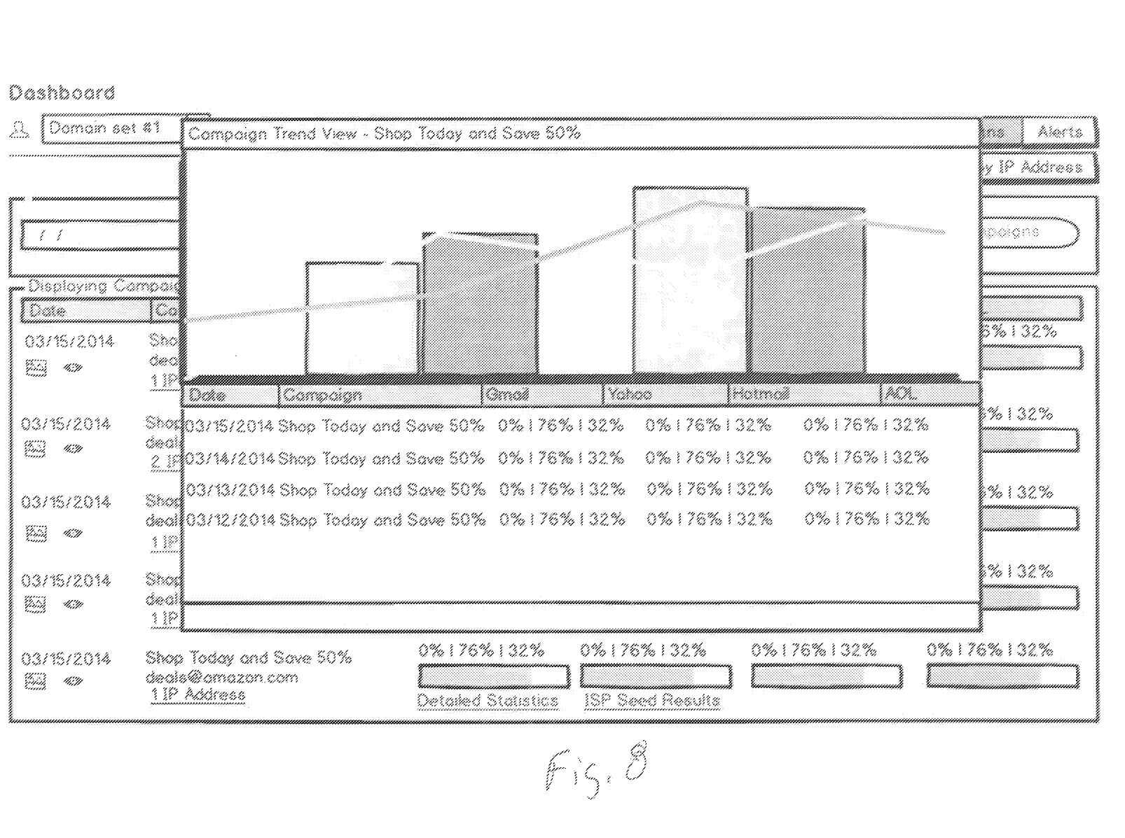

FIGS. 8-10 show examples of dashboards used to access and monitor the transformed data into analytics useable to determine the effectiveness of the email campaign. FIG. 8 depicts an example screenshot of a deliverability dashboard showing the most relevant deliverability information. This information is displayed and provided regardless of the data source. Once the transformed data is aligned, as disclosed above, it can be mixed and matched as desired by the user. FIG. 8 reflects the real-time nature of the raw data collection and shows a single campaign over time.

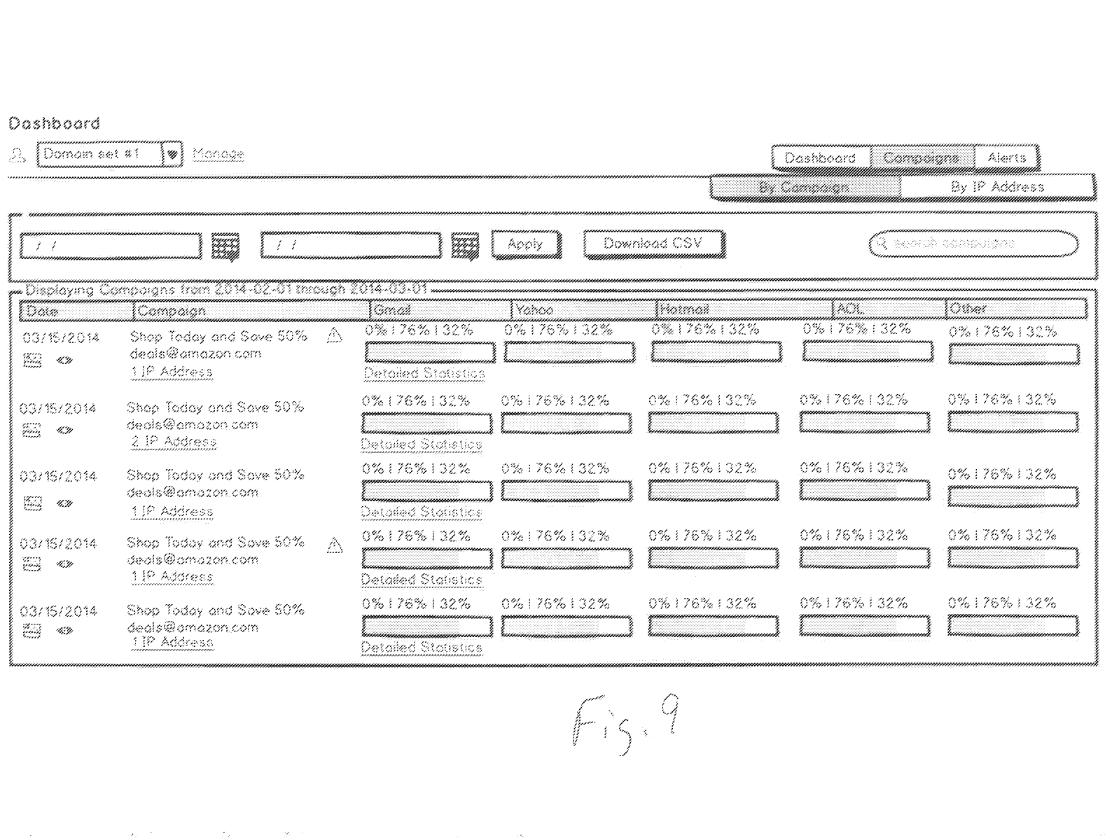

FIG. 9 depicts an example of a screenshot of a campaign view dashboard displaying the most relevant deliverability statistics per ISP, including data based upon virtual personas, seed and subscriber data. No distinction between the datasets is made. Only the most relevant and correct data for the user is displayed. Further, the per-consumer nature of the subscription-based collection allows the display of shared IP addresses among other additional data not available when collected on an aggregate level.

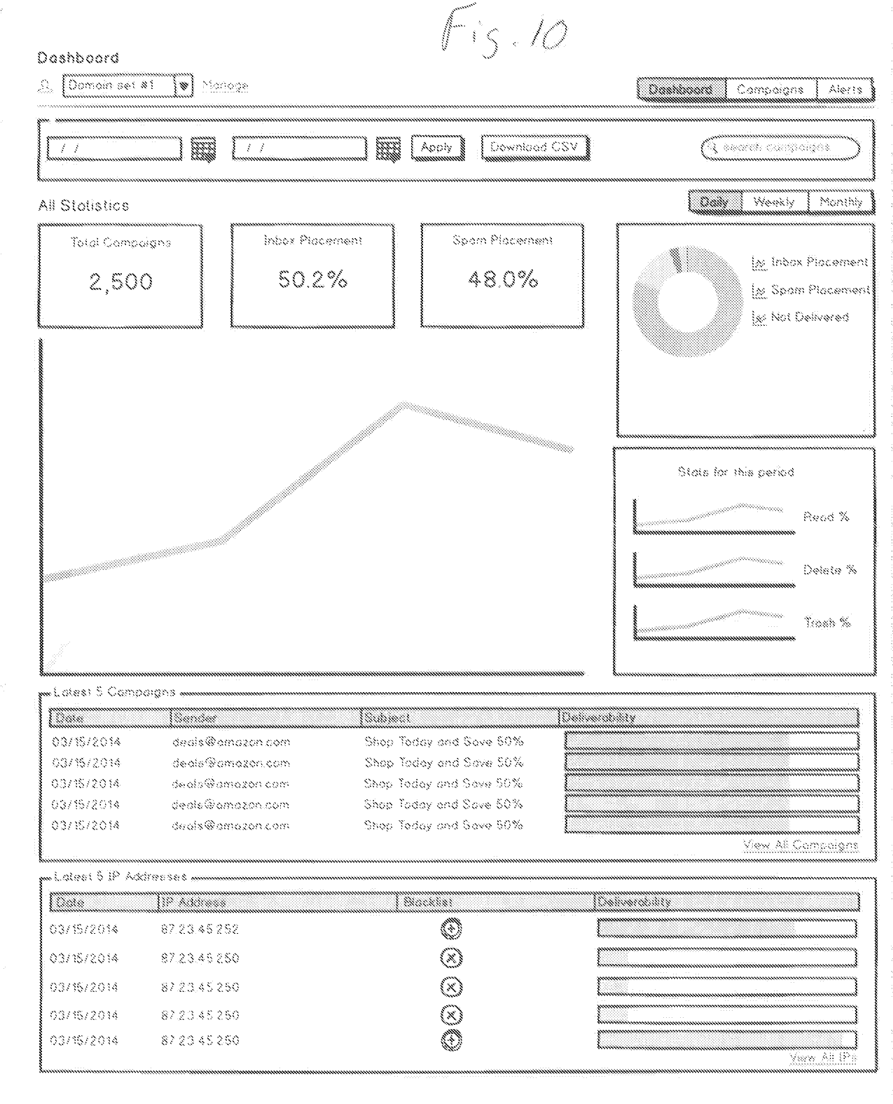

FIG. 10 depicts an example of a screenshot of a combined deliverability and engagement dashboard. No distinction is made between where the data was collected. In other words, the data sources 102, 104 and 106 are not important. Instead, the most relevant data to the user is provided. The raw consumer level data collected allows automatic IP-based detection to be shown without user intervention.

Thus, the disclosed embodiments provide the best statistical results for an email campaign by taking in a variety of raw data sources, including virtual personas and seed accounts. The disclosed embodiments then transform the plurality of email data formats into a common format useable in monitoring processes. The disclosed embodiments use raw email data, and not aggregated inbox data. This allows for the greater amalgamation of data sources for better and accurate statistics.

Aspects of the invention are disclosed in the accompanying description. Alternate embodiments of the present invention and their equivalents are illustrated without parting from the spirit or scope of the present invention. It should be noted that like elements disclosed below are indicated by like reference numerals and the drawings.

The disclosed embodiments may be supported and executed on a platform that has access to a network. The platform may support software and executable programs to provide the functionality disclosed above. For instance, the software may be deployed. Any software embodying the disclosed functions and processes may be deployed by manually loading directly to the client, server and proxy computers via loading a storage medium such a CD, DVD, flash memory, chip, downloadable program and the like. The software also may be automatically or semi-automatically deployed by sending the process software to a central server or a group of central servers. The software is downloaded into the client computers that execute the programs and instructions associated with the software in conjunction with the disclosed camera system.

As will be appreciated by one skilled in the art, the present invention may be embodied as a system, method or computer program product installed on the system. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

In the context of this specification, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce a result including instruction means which implement the function/act specified in the flowchart and/or block diagram block or blocks. Further, these instructions may be used to turn the disclosed network or system from a general purpose system into a special purpose system that performs the functions disclosed above.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof.

Embodiments may be implemented as a computer process, a computing system or as an article of manufacture such as a computer program product of computer readable media. The computer program product may be a computer storage medium readable by a computer system and encoding a computer program instructions for executing a computer process. When accessed, the instructions cause a processor to enable other components to perform the functions disclosed above.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

It will be apparent to those skilled in the art that various modifications and variations can be made in the disclosed methods and systems for monitoring email transactions without departing from the spirit or scope of the invention. Thus, it is intended that the present invention covers these modifications and variations disclosed above provided that such modifications and variations come within the scope of any claims and their equivalents.

1. A method for monitoring deliverability and engagement metrics of electronic mail based upon virtual personas, real subscriber data and traditional seed based monitoring, the method comprising:
registering virtual personas with individual brands in order to receive email marketing communications;
registering subscribers to receive marketing communications;
receiving at a single storage database, seed deliverability data indicating the number of email messages associated with an email campaign that were delivered to inbox or spam folders, based upon a plurality of seed accounts;
receiving at the single storage database, virtual persona data regarding virtual persona emails including a raw unique email message, along with deliverability placement to inbox or spam folders, wherein the virtual persona emails correspond to the registered virtual personas;
receiving at the single storage database, subscriber data regarding real subscriber emails including the raw unique email message, message engagement information, and deliverability placement to inbox or spam folders based upon the Internet service providers (ISPs) message placement, wherein the subscriber emails are associated with registered subscribers of the email campaign;
determining, at a processor, deliverability and engagement metrics based upon a statistical combination of the virtual persona, seed and subscriber data; and
matching, at the processor, a subscriber campaign to the deliverability and engagement metrics by determining a matching criteria.

2. The method of claim 1 further comprising matching a subscriber campaign to virtual persona data by determining a rolling time window based upon subject and sender.

3. The method of claim 1 further comprising matching a subscriber campaign to seed data by determining a matching algorithm based upon subject and sender.

4. The method of claim 1 wherein determining deliverability metrics includes using a computational statistical algorithm to combine the seed, subscriber and virtual character data.

5. The method of claim 1 further comprising determining of a best matching algorithm, where the best matching algorithm uses a computational process to determine which email headers, in addition to a rolling time window, to include as part of the match.

6. The method of claim 1 comprising receiving raw email messages directly from one or more internet service providers (ISPs).

7. The method of claim 1 wherein the subscriber email is obtained using a processor which communicates directly with an email provider via a direct communication protocol.

8. The method of claim 1 further comprising automatically using a new transformed dataset based upon a statistical combination of the subscriber, virtual character and seed data.

9. A method for monitoring deliverability of electronic mail from multiple data sources, the method comprising:
receiving source data of email messages from a plurality of sources by at least one processor, wherein the plurality of sources include a subscriber data source, a virtual persona data source and a seed deliverability data source;
providing the email messages to a distributed queue from the at least one processor;
storing the email messages in a single storage database pulled from the distributed queue using a persist processor;
transforming the email messages pulled from the single storage database into a common dataset using a distributed processing system; and
matching the email messages of the common dataset to at least one commercial campaign using one or more data points within the email messages.

10. The method of claim 9, wherein the matching step includes using a time based-rolling window process to match a first email message to a commercial campaign.

11. The method of claim 9, wherein the matching step includes matching an email message of the email messages using a header key, a subject or a sender data point.

12. The method of claim 9, wherein the matching step includes matching an email message to a commercial campaign if the email message is from a virtual persona data source or a seed deliverability data source.
